(19) United States
(12) Patent Application Publication
(10) Pub. No.: US 2002/0056235 A1
(43) Pub. Date: May 16, 2002

(54) Method and apparatus for hurricane and severe weather protection

(75) Inventors: Robert Olson, Wilmington, NC (US); James E. Goodman, Raleigh, NC (US)

Correspondence Address: DANIEL A THOMSON, 4421 RANCHWOOD SPUR, AKRON, OH, 44333-1343, US

(73) Assignee: Daniel A. Thomson

(21) Appl. No.: 09/568,879

(22) Filed: May 9, 2000

Related U.S. Application Data
(63) Continuation-in-part of application No. 08/843,801, filed on Apr. 21, 1997, now abandoned.

(51) Int. Cl. E06B 3/32

(52) U.S. Cl. 49/464

(57) ABSTRACT

A hurricane and severe weather protection system for protecting an opening in an associated structure includes a first panel having a first outer surface and a core with a lower density and connecting means for connecting the first panel to the associated structure. The panel is formed of a single PVC material or polycarbonate. A panel is customized to properly fit the opening. An insert is then positioned into a frame member near the opening. Next, a thumb turn is partially screwed into the insert. After the bottom portion of a slot in the panel is placed over the thumb turn, the panel is slid downward until the thumb turn contacts the top of the slot. Finally, the thumb turn is tightened.

This application is a continuation-in-part of Ser. No. 08/843,801, filed on Apr. 21, 1997.

### I. BACKGROUND OF THE INVENTION

A. Field of Invention

This invention pertains to the art of methods and apparatuses for storm protection, and more specifically to methods and apparatuses for protecting the openings in homes, buildings and other structures against high winds and flying objects occurring during hurricanes and other storms.

B. Description of the Related Art

It is commonly known that nearly all structures such as homes and buildings are at times exposed to severe winds from storms. Severe winds are especially likely in waterfront areas where hurricanes and typhoons are a known possibility. All such storms can cause extensive damage to structures that are left unprotected. It is known in the art to attempt to protect structures from storms using storm shutters or panels of various types. Typically such panels are formed of plywood, aluminum, or some type of steel.

A common problem in the art deals with the connecting means used to connect panels to a structure. Typically, they require unsightly valances or permanent tracks or channels. For example, U.S. Pat. No. 4,604,827 discloses a channel-shaped frame that receives a shutter element. U.S. Pat. No. 5,426,893 discloses corrugated panel sections that are held in place by means of an upper channel and a lower channel. All such applications detract from the overall appearance of the structure and are expensive.

Another problem known in the art deals with the interlocking means chosen to interlock two or more panels together. The previously mentioned U.S. Pat. No. 4,604,827 discloses the use of vertical cuts in a lower portion into which the upper portion purportedly is received. Such cuts are undesirable because they provide unwanted edges, are unsightly, and furnish opportunity for the cuts to grow. The previously mentioned U.S. Pat. No. 5,426,893 discloses a tongue and channel interlocking means but combines it with corrugated panel sections. Corrugated panels are undesirable because they are unsightly and require panels with large overall widths.

A common problem often encountered with plywood is that it eventually warps, splinters, delaminates, and decays. Thus plywood is a relatively short-term solution for a long-term problem.

Another problem is known when panels of metal or aluminum are used. In high winds they are laborious to handle and can cause severe metal cuts.

The present invention provides improved methods and apparatuses for use in protecting structures from storm damage. Thus, the problems discussed above are overcome in a way that is simple and efficient, while providing better and more advantageous results.

### II. SUMMARY OF THE INVENTION

According to one aspect of the present invention there is provided a hurricane and severe weather protection system for protecting an opening in an associated structure. The hurricane and severe weather protection system includes a first panel having a first outer surface and a core with a lower density and connecting means for connecting the first panel to the associated structure.

According to another aspect of the present invention the hurricane and severe weather protection system includes a second panel wherein the first panel has a first groove and the second panel has a first tongue. Together they form a sturdy tongue and groove connection.

According to another aspect of the present invention the panels are formed of a single material, namely PVC.

According to another aspect of the present invention the hurricane and severe weather protection system includes permanent connecting means such as inserts and a temporary connecting means such as thumb turns.

According to another aspect of the present invention the inserts, when placed within the structure, are flush with the walls.

According to another aspect of the present invention the thumb turns comprise a rod which is selectively connectable to the insert and a handle which is fixedly connected to an end of the rod. The handle has angled grip surfaces or a fluted grip surface.

According to still another aspect of the present invention there is provided a method of protecting an opening in an associated structure. A panel is customized to properly fit the opening. An insert is then positioned into the structure near the opening. Next, a thumb turn is partially screwed into the insert. After the bottom portion of a slot in the panel is placed over the thumb turn, the panel is slid downward until the top portion of the slot contacts the thumb turn. Finally, the thumb turn is tightened.

According to another aspect of the present invention the apparatus for protecting at least one associated opening in an associated structure includes at least one panel formed of a single plastic composite material, the at least one panel having first and second outer surfaces and a core, the core having a lower density than the first and second outer surfaces, the at least one panel having at least first and second slots, connecting means for connecting the at least one panel to the associated structure, the connecting means including permanent connecting means suitable to remain attached to the associated structure when the at least one panel is removed from the at least one associated opening, wherein the permanent connecting means includes at least first and second inserts connected to the associated structure on opposite sides of the at least one associated opening, each of the at least first and second inserts having inner threads, temporary connecting means that is selectively connectable to the permanent connecting means and is suitable to be removed when the at least one panel is removed, wherein the temporary connecting means includes at least first and second thumb turns for use in securing the at least one panel to the associated structure, the first and second thumb turns being selectively received by the first and second slots and the inner threads within the first and second inserts, respectively, wherein the at least one panel is formed of PVC, and wherein the at least one panel has a thickness in the range of 0.60 inches to 1 inch.

According to another aspect of the present invention the apparatus includes a second panel formed of the single plastic composite material, the second panel having first and second outer surfaces and a foam core, the foam core having a lower density than the first and second outer surfaces, the second panel having at least first and second slots, the connecting means also for connecting the second panel to the associated structure, the permanent connecting means including third and fourth inserts connected to the associated structure on opposite sides of the at least one associated opening, each of the third and fourth inserts having inner threads, the temporary connecting means also including third and fourth thumb turns for use in securing the second panel to the associated structure, the third and fourth thumb turns being selectively received by the first and second slots of the second panel and the inner threads within the third and fourth inserts, respectively, and interlocking means for interlocking the panels.

According to another aspect of the present invention the apparatus includes the at least one panel has a first groove and the second panel has a first tongue, the first tongue of the second panel selectively received by the first groove of the at least one panel, and wherein the permanent connecting means is a plug, the insert selectively receiving the plug.

According to another aspect of the invention, the apparatus includes a rod having first and second ends, the first end selectively connectable to the permanent connecting means, and a handle, the handle fixedly connected to the second end of the rod, a washer, the washer fixedly attached to the rod, and wherein the handle has first and second grip regions, the first grip region having first and second grip surfaces, the first and second grip surfaces having a grip angle G1 between them, the grip angle G1 in the range of 950° to 175°, the handle having a fluted grip surface, a hollow region, the hollow region being located between the fluted grip surface and the second end of the rod.

According to yet another aspect of the present invention, the apparatus includes a tool opening for receiving an associated tool, the thumb turn being selectively connectable to the permanent connecting means by the associated tool, wherein the first panel has a first slot having a bottom portion with a diameter D1 and a top portion with a diameter D2, the diameter D1 being larger than diameter D2, the washer having a diameter D3, the bottom portion selectively receiving the thumb turn, the diameter D1 being larger than diameter D3, the diameter D2 being smaller than D3, and a retainer for holding the at least one panel, the retainer having a first outer surface and a core, the core having a lower density than the first outer surface.

According to another aspect of the present invention a method of protecting an associated opening in an associated structure, the method includes the steps of customizing at least one panel for the at least one associated opening in the associated structure,connecting a first insert into the associated structure, fastening a fastening means partially into the first insert, placing a bottom portion of a first slot on the at least one panel over the fastening means, sliding the at least one panel downward until the fastening means contacts the top of the first slot, tightening the fastening means, holding the at least one panel against the structure in its desired location, drilling a hole through the top portion of a slot in the at least one panel into the structure, and interlocking the panels.

According to another aspect of the present invention, the method includes the steps of extruding a plastic material into at least one panel having first and second outer surfaces and a foam core wherein the foam core has a lower density than the first and second outer surfaces, customizing the at least one panel to the appropriate size and shape for the at least one associated opening in the associated structure including at least first and second slots, attaching at least first and second inserts each having inner threads to the associated structure on opposite sides of the at least one associated opening such that the first and second inserts are suitable to remain attached to the associated structure when the at least one panel is removed from the at least one associated opening, extruding the plastic material into a second panel having first and second outer surfaces and a foam core wherein the foam core has a lower density than the first and second outer surfaces, customizing the second panel in combination with the at least one panel to the appropriate size and shape for the at least one associated opening in the associated structure including at least first and second slots, attaching third and fourth inserts each having inner threads to the associated structure on opposite sides of the at least one associated opening such that the third and fourth inserts are suitable to remain attached to the associated structure when the second panel is removed from the at least one associated opening, interlocking the panels, screwing at least first and second thumb turns through the first and second slots, respectively and into the first and second inserts, respectively such that the at least one panel is secured to the associated structure and the first opening is fully covered, and screwing at least third and fourth thumb turns through the first and second slots of the second panel, respectively and into the third and fourth inserts, respectively such that the second panel is secured to the associated structure.

According to still another aspect of the present invention a method for storing associated hurricane and severe weather protection apparatus, the method comprising the steps of providing a structure having at least two sides, a top, and a bottom, the at least two sides being connected to the top and the bottom, one the at least two sides or the top capable of being opened, the structure being of an appropriate size to contain the associated hurricane and severe weather protection apparatus, and placing the associated hurricane and severe weather protection apparatus into the structure.

According to another aspect of the invention an apparatus for protecting at least one associated opening in an associated structure includes at least first and second panels, the first panel having at least one opening, the at least one opening having a diameter D5, the second panel having a diameter D6, diameter D6 being greater than diameter D5, a handle, the handle connected to the second panel, and fastening means for fastening the second panel to the first panel.

One advantage of the invention is that the panels are secured to the structure without the use of unsightly tracks or channels. A number of small inserts are the only hardware to be installed permanently.

Another advantage of the invention is that the panels are of minimum thickness though optionally interlockable using a sturdy tongue and groove design. This reduces overall weight and expense.

Another advantage of the invention is that the panels are long lasting and will not warp, splinter, delaminate or decay. The panels are virtually impervious to ultraviolet decay, water damage, and house hold chemicals. They are formed of an impact resistant plastic composite material.

Another advantage of the invention is that the panels are lightweight and easy to handle. The panels are designed to be carried under the arm or by the slot. They can easily be installed and removed by a single person with little effort. They can be threaded into a lock position by hand or by using a drill.

Another advantage of the invention is that the panels are individually designed for a custom fit. Openings of any shape or size can be properly protected.

Another advantage of the invention is that in cases where the opening does not have an accessible frame, retainers can be used to hold the panels firmly in place.

Still another advantage of the invention is that when the panels are not on the structure, the installed hardware is virtually invisible and does not pose any hazards by having protruding parts.

Yet another advantage of the invention is that the cellular foam PVC used withstands UV rays, is fire retardant, is flexible, and is easily cut using a router.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a front view of a window with a frame mounted to a structure;

FIG. 2 is a front view of the window of FIG. 1 protected by the hurricane and severe weather protection system of this invention;

FIG. 3 is a front view of a first panel showing the top and bottom portions of a slot;

FIG. 4 is a side view taken along the line 44 of FIG. 3 showing the outer surfaces and the core of the first panel as well as its first groove;

FIG. 5 is a front view of a second panel showing the first tongue which is received by the first groove of FIG. 4;

FIG. 6 is a side view taken along the line 6-6 of FIG. 5 showing the width and thickness of the panel;

FIG. 7 is a sectional side view of one of the inserts which may be used with this invention;

FIG. 8 is a sectional side view of another insert showing a plug which is received within the inner threads of the insert;

FIG. 9 is a sectional side view of a third insert which may be used with this invention;

FIG. 10 is a side view of the first thumb turn of this invention showing the rod, the washer and the handle;

FIG. 11 is a front view taken along the line 11-11 of FIG. 10 showing the first and second grip regions of the handle;

FIG. 12 is side view of the second thumb turn of this invention showing the rod and the handle;

FIG. 13 is a second end view of the second thumb turn taken along the line 13-13 of FIG. 12 showing the tool opening and the flutes;

FIG. 14 is a first end view of the second thumb turn taken along the line 14-14 of FIG. 12 showing the fluted grip surface and the hollow region;

FIG. 15 is a front view of a structure having insufficient built-in framing around a window;

FIG. 16 is a front view of the window of FIG. 15 protected by panels held in place using a retainer;

FIG. 17 is a front view of another embodiment of the invention, wherein the panels can be placed onto the house from the inside;

FIG. 18 is a perspective view of a storage box for storing the protective apparatus;

FIG. 19 is a front view of the panels;

FIG. 19A is a side view of the panels, showing the H-channels; and, FIG. 19B is an exploded side view of the H-channels.

### IV. DESCRIPTION OF THE PREFERRED EMBODIMENT

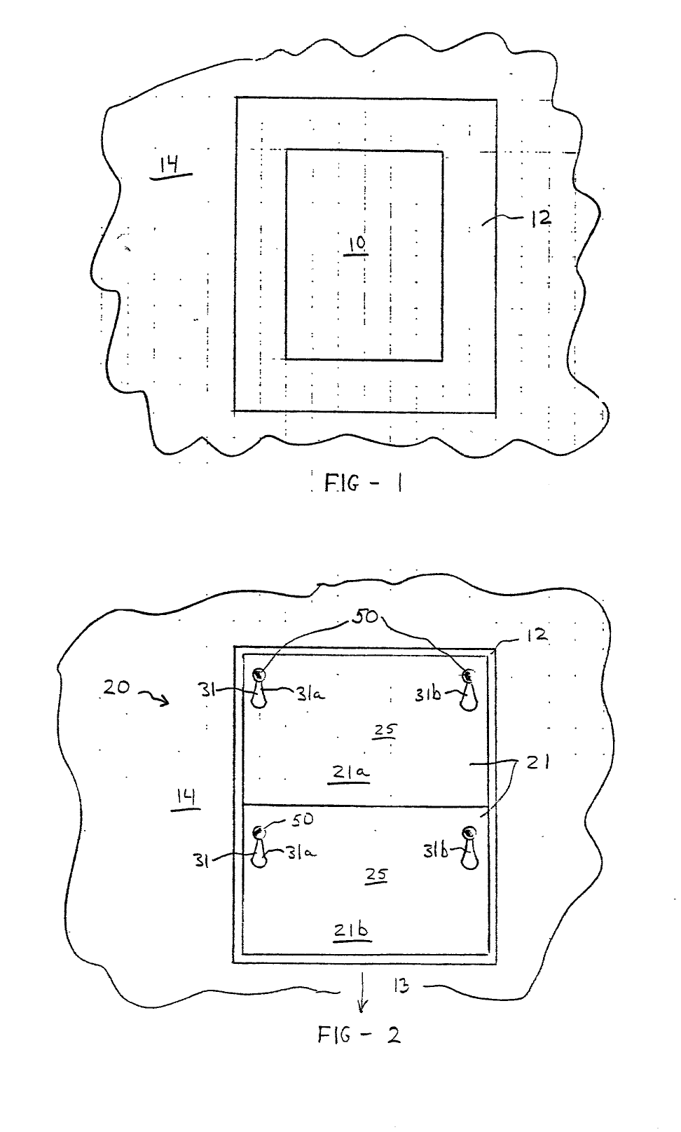

Referring now to the drawings wherein the showings are for purposes of illustrating a preferred embodiment of the invention only and not for purposes of limiting the same, FIG. 1 shows an opening, window 10, which may be found in a structure 14 such as a home or a building. Though a window 10 is pictured in this embodiment it must be noted that the current invention is applicable also for doors (not shown), vents (not shown) or any other type of opening. Window 10 is surrounded by frame 12. FIG. 2 shows the hurricane and severe weather protection system 20 of the present invention which protects an opening, such as window 10, from severe winds and flying objects such as those caused by hurricanes, typhoons and other storms.

With reference to FIGS. 2-6, the hurricane and severe weather protection system 20 includes at least one panel 21. Only one panel 21 is required for this invention but any number of panels 21 chosen with sound engineering judgement can be used. Each panel 21, such as first and second panels 21a, 21b, has first and second outer surfaces 25, 26 and a core 27. The panels 21a, 21b may be generally planar in shape as shown. Preferably, the core 27 has a lower density than the first and second outer surfaces 25, 26 so that the overall weight of the panel 21 is reduced making it easy to handle, install and remove while maintaining the required structural strength. The first and second outer surfaces 25, 26 are relatively hard and smooth, making the panel 21 puncture and impact resistant while improving its appearance. Therefore, as seen in FIGS. 4 and 6, the outer surfaces 25, 26 cover, and therefore, protect the core 27. In this preferred embodiment the panels 21 are formed of a single material making them easy to fabricate. Preferably, the panels 21 are formed of a dense plastic composite material such as poly (vinyl) chloride (also known as PVC). The preferred PVC material is commercially available as InteCel® and made into sheets by World-Pak which is a subsidiary of Inteplast of Livingston, N.J. The PVC sheets are extruded to have an outer surface, such as first and second outer surfaces 25, 26, and a foam core, such as core 27, as disclosed above. The panels 21 can have any thickness Ti chosen with sound engineering judgement but preferably the thickness T1 is in the range of 0.60 inches to 1.00 inches.

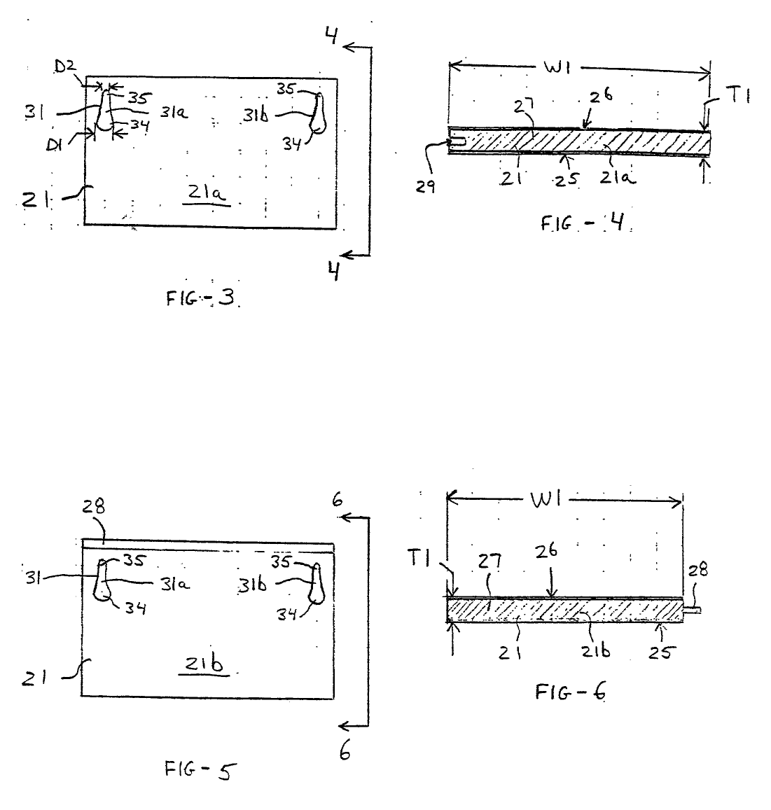

With reference now to FIGS. 3-6, each panel has a slot 31 such as first and second slots 31a, 31b. Two slots 31 are preferred for each panel 21 when the panel width W1 is less than 12.0 inches. When the panel width W1 is 12.0 inches or greater at least four slots 31 are preferred, two on each side of the panel 21. This is especially true when the panel 21, such as second panel 21b, is positioned at the bottom of the opening of the structure. Of course any number of slots 31 chosen with sound engineering judgement can be used for this invention. Each slot 31 has a bottom portion 34 and a top portion 35. The bottom portion 34 is preferably partially circular with a diameter D1 and top portion 35 is preferably partially circular in shape with a diameter D2. Diameter D1 is larger than diameter D2 for reasons to be explained below. Optionally but preferably, when two or more panels 21, such as first and second panel 21a, 21b, will be used to cover a single opening, they are interlockable. Any interlocking means chosen with sound engineering judgement can be used but in this preferred embodiment a tongue and groove interlocking means is used. Second panel 21b, for example, has a first tongue 28 and first panel 21a has a first groove 29. As shown in FIGS. 4-6, the first groove 29 is positioned within the core 27 of the first panel 21a and the first tongue 28 extends from, and is integral with, the core 27 of the second panel 21b. It is preferred, also as shown in FIGS. 4-6, that the first tongue 28 and first groove 29 each extend the width of the respective panels 21b, 21a. During installation, first tongue 28 is received by first groove 29 providing a sturdy interlocking connection.

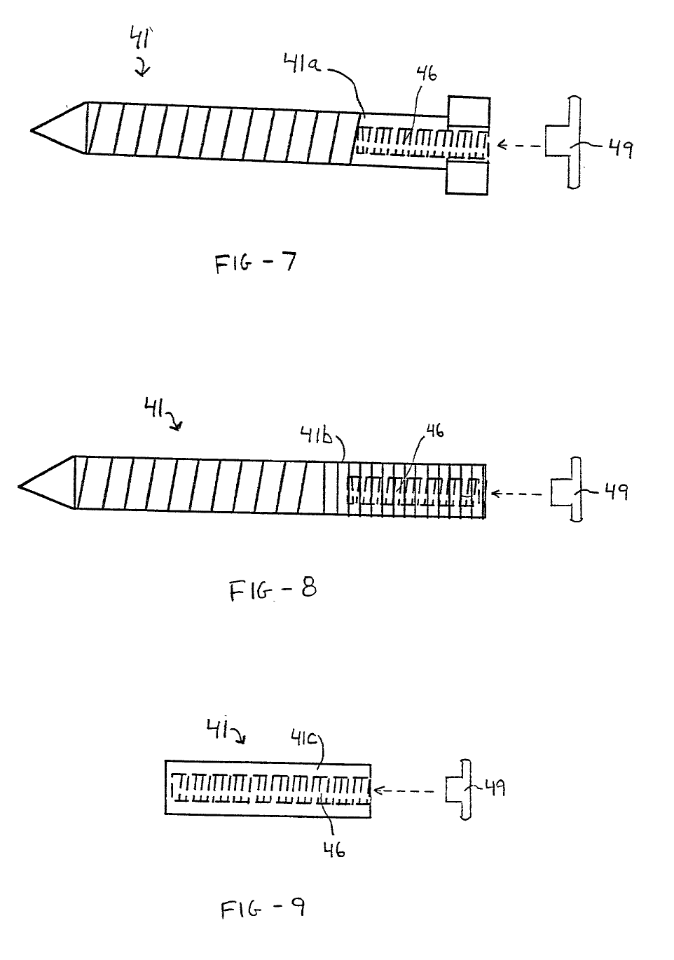

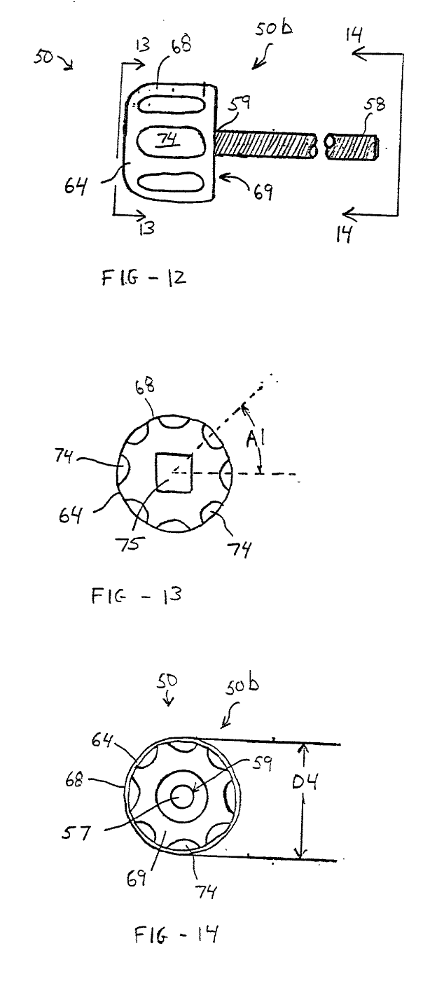

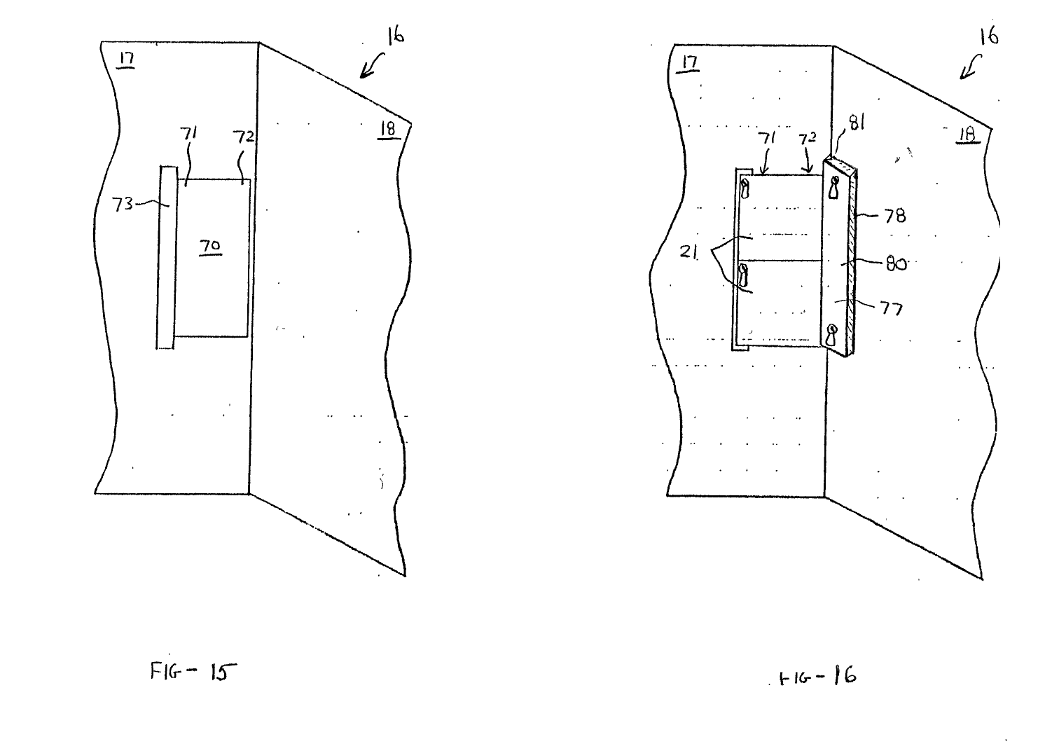

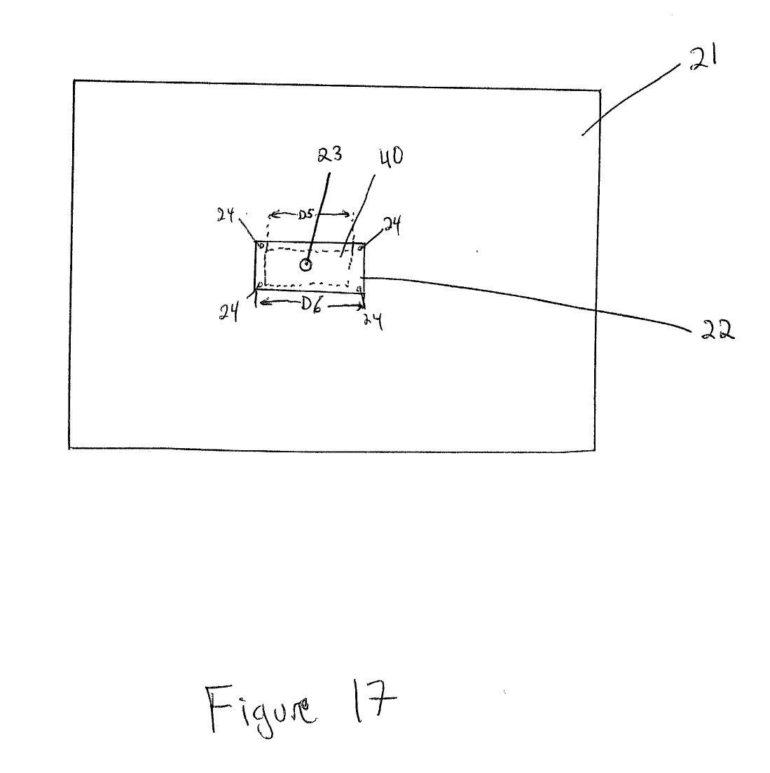

With reference now to FIGS. 1-2 and 7-14, the panels 21, such as first and second panels 21a, 21b, are secured to a structure, such as structure 14, by connecting means. In this preferred embodiment the connecting means comprises permanent connecting means and temporary connecting means. The permanent connecting means remain attached to the structure even when the panels 21 are removed. Preferably the permanent connecting means is a number of inserts 41 chosen with sound engineering judgement. The type of insert 41 used will depend on the material the insert 41 will be connected too. Inserts 41a, 41b for example, shown in FIGS. 7 and 8, are to be used when mounting a panel 21 to a wood frame structure with vinyl, masonite, shingle, synthetic stucco, or clapboard siding. Inserts 41a, 41b would be ideal, for example, for use with frame 12, shown in FIGS. 1-2, if frame 12 was formed of wood. Insert 41c, shown in FIG. 9, is epoxied in a hole (not shown) drilled into a facade of a structure. Insert 41c is to be used when mounting a panel 21 to a structure with a masonry or concrete exterior. All such inserts 41, which are preferably formed of brass, are connected to the structure 14 by means currently known in the art. Other inserts chosen with sound engineering judgement can also be used for this invention. Each insert 41 preferably has inner threads 46 for receiving the temporary connecting means as will be discussed further below. It should be noted that for the hurricane and severe weather protection system 20 of this invention, the inserts 41 are the only hardware items which remain connected to the structure when the panels 21 are removed. Optionally but preferably, a plug 49 can be selectively pushed into each insert 41 when panels 21 are removed. Plugs 49, which are preferably made of nylon, protect inner threads 46 and are selectively sized and colored to become virtually unseen by an observer looking at structure 14.

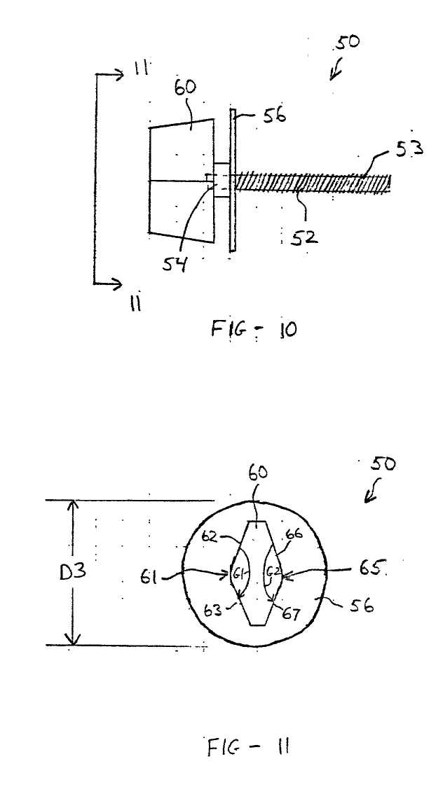

With reference now to FIGS. 2, 4, 6-9 and 10-11, the temporary connecting means is selectively connectable to the permanent connecting means. In this preferred embodiment the temporary connecting means is a thumb turn 50, such as first thumb turn 50a shown in FIGS. 10 and 11 or second thumb turn 50b shown in FIGS. 12-14. The first thumb turn 50a includes a rod 52, preferably made of brass, having first and second ends 53, 54. The first end 53 is selectively connectable to the permanent connecting means. Preferably the first end 53 is threaded and received by inner threads 46 of insert 41. The first thumb turn 50a also includes a washer 56 having a diameter D3. Washer 56, which is fixedly attached to the rod 52 by means known in the art, contacts the first outer surface 25 of panel 21 surrounding the top portion 35 of slot 31 when the first thumb turn 50a is tightened. First thumb turn 50a also includes a handle 60 that is fixedly connected by means known in the art to the second end 54 of rod 52. The handle 60 is designed to be selectively turned by hand or by a drill. Handle 60 has first and second grip regions 61, 65 each having first and second grip surfaces 62, 63 and 66, 67 respectively. First and second grip surfaces 62, 63 of first grip region 61 have a grip angle G1 between them. Likewise, first and second grip surfaces 66, 67 of second grip region 65 have a grip angle G2 between them. The grip angles G1, G2 can be any angle chosen with sound engineering judgement but in this preferred embodiment are in the range of 95° to 175°.

With reference now to FIGS. 12-14, the thumb turn 50 used for the temporary connecting means could alternately be the second thumb turn 50b. The second thumb turn 50b also includes a handle 64 fixedly connected to a second end 59 of a rod 57 having a threaded first end 58. A washer is not required for the second thumb turn 50b. The handle 64 has a diameter D4, a fluted grip surface 68 and a hollow region 69 located between the fluted grip surface 68 and the second end 59 of the rod 57. The hollow region 69 enables the handle 64 to have the desired diameter D4 while maintaining a light overall weight. Flutes 74 are positioned around the circumference of the fluted grip surface 68 to make manual gripping of the handle 64 easy and efficient. Any number of flutes 74 positioned with sound engineering judgement can be used for this invention. In this preferred embodiment, eight flutes 74 are used and are positioned at a flute angle A1 from each other. The flute angle Al is in the range of 10° to 90° though 45° is preferred. The handle 64 also has a tool opening 75 for receiving an associated tool (not shown) such as a socket or drill bit. The tool opening 75 permits the second thumb turn 50b to be selectively connectable to the insert (referred to as item 41 in FIGS. 7-9) by the associated tool. Preferably, the tool opening 75 is square shaped.

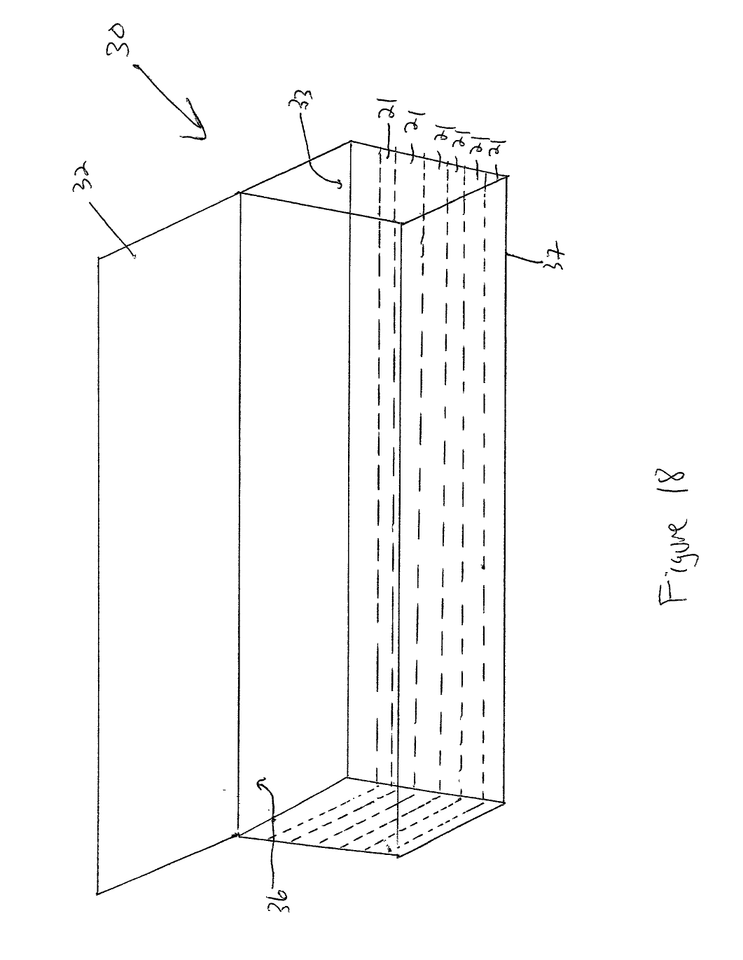

With reference now to FIGS. 15-16, it may occur that a structure will have insufficient built-in framing around its opening. Structure 16, for example, has first and second walls 17, 18. First wall 17 has a window 70 having a first side 71 with a frame 73 and a second side 72 without sufficient framing for connecting panels 21. In such a case, panels 21 can be connected to the first side 71 of window 70 using frame 73 as discussed above. The panels 21 can be supported on the second side 72 of window 70 using retainer 80. Retainer 80 has a first side 81 that holds panels 21 against first wall 17. Retainer 80, which is rigidly connected to second wall 18, can be sized, shaped and made of any material chosen with sound engineering judgment. Preferably, however, retainer 80 is made of the same material as panels 21 as disclosed above. Thus, preferably retainer 80 has a core 78 that has a lower density than its first outer surface 77. Further, retainer 80 is preferably connected to second wall 18 using the same connecting means disclosed above. In this way retainer 80 can be selectively installed and removed from second wall 18 in the same manner as panels 21. It should be noted that a retainer 80 could be used similarly to support a panel 21 by connecting to a floor member (not shown), a ceiling member (not shown) or any other suitable surface near the opening of a structure.

With reference now to FIGS. 1-14, to protect an opening such as window 10 in a structure 14 using the hurricane and severe weather protection system 20 of the current invention, one or more panels 21 are customized. By customized it is meant that the panels 21 are sized and shaped corresponding to the requirement for the opening. Customizing a panel 21 would also include the formation of slots 31 in numbers and locations chosen with sound engineering judgement. Next, a number of inserts 41 corresponding to the number of slots 31 are connected to the structure 14 around the opening such as in the frame 14 around window 10. The inserts 41 are located in accordance with the desired locations of the top portions 35 of the slots 31. An optional but preferred means for locating the inserts 41 is to hold the panel 21 against the structure 14 in its desired location and then drill holes (not shown) through the top portions 35 of the slots 31 into the structure 14. The inserts 41 can be connected to the drilled holes (not shown) by means known in the art. Thumb turns 50 are then partially screwed into the inner threads 46 of each insert 41. By partially screwed it is meant that the thumb turns 50 are threaded into the inserts 41 such that the thumb turns 50 are connected to the inner threads 46 without requiring any additional support yet the distance between the handle (60 or 64) and the first outer surface 25 of the panel 21 is greater than the thickness T1 of the panel 21. This permits the sliding of a panel 21 between the structure 14 and the partially screwed thumb turns 50 as will be discussed below. A panel 21 is then placed over the thumb turns 50 such that the bottom portions 34 of the slots 31 receive the thumb turns 50. It should be noted that this is possible because the diameter D1 of bottom portion 34 is larger than the diameter D3 of washer 56. The diameter D1 is also larger than the diameter D4 of the handle 64. Next, the panel 21 is slid in downward direction 13 until the top potions 35 of the slots 31 contact the rods 52 of the thumb turns 50. Finally, the thumb turns 50 are tightened such that the washers 56 of the first thumb turns 50a or the handles 64 of the second thumb turns 50b hold the panels 21 firmly in place against the structure 14. It should be noted that this is possible because the diameter D2 of top portion 35 is smaller than the diameter D3 of washer 56. The diameter D2 is also smaller than the diameter D4 of the handle 64. When two panels 21 are used, such as first and second panels 21a, 21b, once the panels 21 are customized, inserts 41 are connected and thumb turns 50 are partially screwed, all as disclosed above, second panel 21b is slid into place also as disclosed above. First panel 21a is then similarly slid into place such that first groove 29 receives first tongue 28 of second panel 21b. Thumb turns 50 are then tightened. If required, a retainer, such as retainer 80 (shown in FIG. 16) may also be installed.

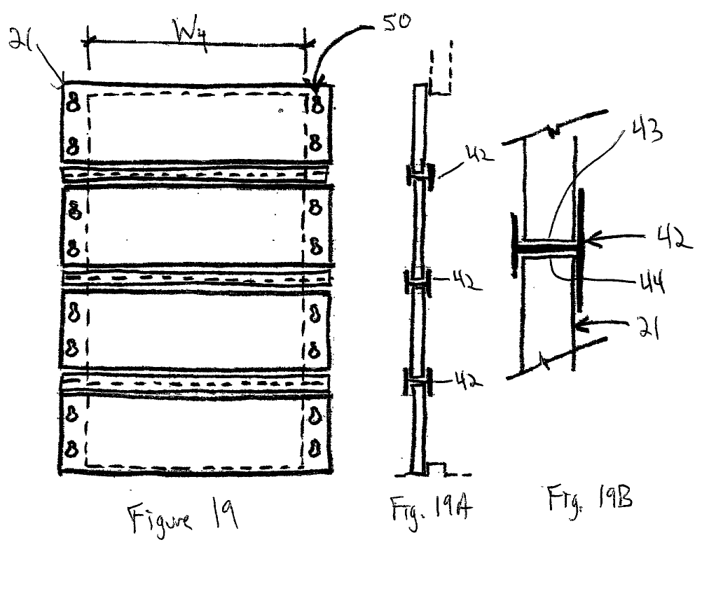

With reference now to FIG. 17, another embodiment of the invention is shown. One, or all, of the panels 21′ may have an opening 40 in the panel 21′. The size and shape of the opening 40 is not important to the invention, and can be any size or shape, as long as chosen using sound engineering judgment. A second, or opening, panel 22 is used to cover the opening 40. This embodiment allows the user to attach the panels 21′ to their house from the inside. The opening 40 has a diameter D5 and the opening panel 22 has a diameter D6, a handle 23, and fastening means 24. In this embodiment, the diameter D6 is greater than the diameter D5.

Once the user attaches the panels 21′ by the same method as described earlier in the application, the user holds the handle 23 and pulls the opening panel 22 against the panel 21′. Once the opening panel 22 is against the panel 21′, the user fastens the opening panel 22 to the panel 21′ via the fastening means 24. In this embodiment, the fastening means 24 are stainless steel, ¼″−20 T-nuts. However, any fastening means, chosen using sound engineering judgment, can be used.

With reference now to FIG. 18, a storage means 30 is shown, including a top 32, a bottom 37, a first side 33, and a second side 36. The storage means 30 is custom designed so that it is the appropriate size to store the panels 21 when the panels 21 are not in use. The storage means 30 is shown as a rectangular box in FIG. 18, but it is to be understood that any storage means 30, chosen using sound engineering judgment, and custom designed to contain the panels 21, can be used.

With reference to another embodiment of this invention, the panels 21, 21′ can be made of a shatter-resistant, clear plastic material such as polycarbonate. The clear material allows the homeowner to look out of the windows, while maintaining the protection from the elements. The plastic material has to be strong enough to withstand a hurricane, but still allow sunlight and viewing.

With reference now to FIGS. 19, 19A, and 19B, the panels 21 are shown with H-channel connectors 42 connecting the individual panels 21. Each panel 21 has top edge 44 and a bottom edge 32. The H-channels 42 fit around the panels 21 as shown in FIG. 19B. The channels 42 have a cross-bar (shown, but not referenced) and two vertical sides (shown, but not referenced), just like the letter “H.” The cross-bar rests between the bottom and top edges 43, 44 of the panels 21, as shown in FIG. 19B, and the vertical sides of the channels 42 extend upwardly and downwardly from the cross-bar to contain the bottom and top edges 43, 44 of the panels 21. The channels 42 can either extend the entire length of the edges 43, 44 of the panels 21, or be any length desired. The channels 42 can be designed to fit any size or shape panel 21. In this embodiment, the channels 42 are made of aluminum, but any material can be used, as long as chosen using sound engineering judgment. The channels 42 allow greater strength in the system, while allowing the panels 21 to be flexible during a storm.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

What is claimed is:

1. An apparatus for protecting at least one associated opening in an associated structure, the apparatus comprising:
a at least one panel formed of a single plastic composite material, the at least one panel having first and second outer surfaces and a core, the core having a lower density than the first and second outer surfaces, the at least one panel having at least first and second slots;
connecting means for connecting the at least one panel to the associated structure, the connecting means including:
permanent connecting means suitable to remain attached to the associated structure when the at least one panel is removed from the at least one associated opening, wherein the permanent connecting means includes at least first and second inserts connected to the associated structure on opposite sides of the at least one associated opening, each of the at least first and second inserts having inner threads; and,
temporary connecting means that is selectively connectable to the permanent connecting means and is suitable to be removed when the at least one panel is removed.

2. The apparatus of claim 1, wherein the temporary connecting means includes at least first and second thumb turns for use in securing the at least one panel to the associated structure, the first and second thumb turns being selectively received by the first and second slots and the inner threads within the first and second inserts, respectively.

3. The apparatus of claim 2, wherein the at least one panel is formed of PVC.

4. The apparatus of claim 3 wherein the at least one panel has a thickness in the range of 0.60 inches to 1 inch.

5. The apparatus of claim 2 further comprising:
a second panel formed of the single plastic composite material, the second panel having first and second outer surfaces and a foam core, the foam core having a lower density than the first and second outer surfaces, the second panel having at least first and second slots, the connecting means also for connecting the second panel to the associated structure, the permanent connecting means including third and fourth inserts connected to the associated structure on opposite sides of the at least one associated opening, each of the third and fourth inserts having inner threads, the temporary connecting means also including third and fourth thumb turns for use in securing the second panel to the associated structure, the third and fourth thumb turns being selectively received by the first and second slots of the second panel and the inner threads within the third and fourth inserts, respectively; and,
interlocking means for interlocking the panels.

6. The apparatus of claim 5 wherein the at least one panel has a first groove and the second panel has a first tongue, the first tongue of the second panel selectively received by the first groove of the at least one panel.

7. The apparatus of claim 5 wherein the permanent connecting means further comprises:
a plug, the insert selectively receiving the plug.

8. The apparatus of claim 7 wherein the thumb turns further comprise:
a rod having first and second ends, the first end selectively connectable to the permanent connecting means; and,
a handle, the handle fixedly connected to the second end of the rod.

9. The apparatus of claim 8 further comprising:
a washer, the washer fixedly attached to the rod; and,
wherein the handle has first and second grip regions, the first grip region having first and second grip surfaces, the first and second grip surfaces having a grip angle G1 between them, the grip angle G1 in the range of 95° to 175°.

10. The apparatus of claim 9 wherein the second grip region comprises:
first and second grip surfaces, the first and second grip surfaces having a grip angle G2 between them, the grip angle G2 in the range of 95° to 175°.

11. The apparatus of claim 8 wherein the handle comprises:
a fluted grip surface; and,
a hollow region, the hollow region being located between the fluted grip surface and the second end of the rod.

12. The apparatus of claim 11 wherein the handle further comprises:
a tool opening for receiving an associated tool, the thumb turn being selectively connectable to the permanent connecting means by the associated tool.

13. The apparatus of claim 9 wherein the first panel has a first slot having a bottom portion with a diameter D1 and a top portion with a diameter D2, the diameter D1 being larger than diameter D2, the washer having a diameter D3, the bottom portion selectively receiving the thumb turn, the diameter D1 being larger than diameter D3, the diameter D2 being smaller than D3.

14. The apparatus of claim 11 wherein the first panel has a first slot having a bottom portion with a diameter D1 and a top portion with a diameter D2, the diameter D1 being larger than diameter D2, the handle having a diameter D4, the bottom portion selectively receiving the thumb turn, the diameter D1 being larger than diameter D4, the diameter D2 being smaller than diameter D4.

15. The apparatus of claim 1 further comprising:
a retainer for holding the at least one panel, the retainer having a first outer surface and a core, the core having a lower density than the first outer surface.

16. A method of protecting an associated opening in an associated structure, the method comprising the steps of:
customizing at least one panel for the at least one associated opening in the associated structure;
connecting a first insert into the associated structure;
fastening a fastening means partially into the first insert;
placing a bottom portion of a first slot on the at least one panel over the fastening means;
sliding the at least one panel downward until the fastening means contacts the top of the first slot; and,
tightening the fastening means.

17. The method of claim 16 after the step of customizing at least one panel for the at least one associated opening in the associated structure having the steps of:
holding the at least one panel against the structure in its desired location; and,
drilling a hole through the top portion of a slot in the at least one panel into the structure.

18. The method of claim 16 after the step of sliding the at least one panel downward until the fastening means contacts the top of the first slot having the step of:
interlocking the panels.

19. A method of protecting at least one associated opening in an associated structure, the method comprising the steps of:
extruding a plastic material into at least one panel having first and second outer surfaces and a foam core wherein the foam core has a lower density than the first and second outer surfaces;
customizing the at least one panel to the appropriate size and shape for the at least one associated opening in the associated structure including at least first and second slots;
attaching at least first and second inserts each having inner threads to the associated structure on opposite sides of the at least one associated opening such that the first and second inserts are suitable to remain attached to the associated structure when the at least one panel is removed from the at least one associated opening;
screwing at least first and second thumb turns through the first and second slots, respectively and into the first and second inserts, respectively such that the at least one panel is secured to the associated structure and the first opening is fully covered.

20. The method of claim 19 wherein, before the step of screwing at least first and second thumb turns through the first and second slots, respectively and into the first and second inserts, respectively such that the at least one panel is secured to the associated structure and the at least one associated opening is fully covered, the method comprises the steps of:
extruding the plastic material into a second panel having first and second outer surfaces and a foam core wherein the foam core has a lower density than the first and second outer surfaces;
customizing the second panel in combination with the at least one panel to the appropriate size and shape for the at least one associated opening in the associated structure including at least first and second slots;
attaching third and fourth inserts each having inner threads to the associated structure on opposite sides of the at least one associated opening such that the third and fourth inserts are suitable to remain attached to the associated structure when the second panel is removed from the at least one associated opening;
interlocking the panels; and,
screwing at least third and fourth thumb turns through the first and second slots of the second panel, respectively and into the third and fourth inserts, respectively such that the second panel is secured to the associated structure.

22. The apparatus of claim 1, wherein the at least one panel is made of a shatter-resistant and transparent plastic material.

23. The apparatus of claim 5, wherein the panels are connected by an H-shaped channel.

24. The method of claim 19, wherein attaching at least first and second inserts each having inner threads to the associated structure on opposite sides of the at least one associated opening such that the first and second inserts are suitable to remain attached to the associated structure when the at least one panel is removed from the at least one associated opening, further comprises the step of:
attaching at least first and second inserts each having inner threads to the associated structure on opposite sides of the at least one associated opening such that the first and second inserts are suitable to remain attached to the associated structure when the at least one panel is removed from the at least one associated opening, the inserts being substantially flush with the associated structure.

25. A method for storing associated hurricane and severe weather protection apparatus, the method comprising the steps of:
providing a structure having at least two sides, a top, and a bottom, the at least two sides being connected to the top and the bottom, one the at least two sides or the top capable of being opened, the structure being of an appropriate size to contain the associated hurricane and severe weather protection apparatus;
placing the associated hurricane and severe weather protection apparatus into the structure.

26. An apparatus for protecting at least one associated opening in an associated structure, the apparatus comprising:
at least first and second panels, the first panel having at least one opening, the at least one opening having a diameter D5, the second panel having a diameter D6, diameter D6 being greater than diameter D5;
a handle, the handle connected to the second panel; and,
fastening means for fastening the second panel to the first panel.

27. The apparatus of as in any of claims 1-15, 22-23, in which the apparatus further comprises:
at least one of the panels has at least one opening, the at least one opening having a diameter D5;
an opening panel, the opening panel having a diameter D6, diameter D6 being greater than diameter D5; and,
fastening means for fastening the opening panel to the at least one of the panels.
